(19) United States
(12) Patent Application Publication
(10) Pub. No.: US 2003/0143325 A1
(43) Pub. Date: Jul. 31, 2003

(54) Method to powder coat non-metallic substrates and the articles formed thereby

(76) Inventor: Edward G. Nicholl, Reading, PA (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/351,692

(22) Filed: Jan. 27, 2003

Related U.S. Application Data
(60) Provisional application No. 60/353,092, filed on Jan. 30, 2002.

(51) Int. Cl. B05D 1/12

(52) U.S. Cl. 427/180

(57) ABSTRACT

A method of powder coating a substrate includes cooling the non-metallic substrate, condensing a vapor at a surface of the non-metallic substrate, and disposing a coating powder at the condensed vapor. The vapor may be water, and the substrate may be non-metallic, preferably a wood, for example fiberboard or engineered wood. The powder coatings formed thereby are more uniform and less prone to distortion or cracking.

### BACKGROUND

This disclosure relates generally to the application of coating powders to non-metallic substrates, and the articles formed thereby.

Coating powders are dry, finely divided, free flowing, solid materials at room temperature. Upon application to a surface, they are heated to fuse and optionally cure, thereby forming a powder coating. They are conveniently applied using electrostatic methods, wherein an electric potential is generated between the coating powder and the substrate to be coated, causing the powder particles to be attracted to the substrate. Where coating powders are applied to a non-metallic substrate, the substrate is often made artificially conductive, for example by heating to drive moisture from the core of the substrate to the surface. Such heating can also cause some shrinkage of the substrate and/or some evaporation of the moisture from the surface, resulting in an uneven distribution of the moisture, which results in uneven deposition of the coating powder, and which ultimately yields a non-uniform powder coating after fusion and cure. If the powder coating is non-uniform over the surface of the substrate, over time moisture may evaporate at a non-uniform rate from the surface area, causing the substrate to warp, and stressing the powder coating. Stress applied to the powder coating may result in the occurrence of interruptions in the continuity of the coating, thereby resulting in the formation of blemishes, cracks, or other surface defects. Similarly, where the substrate is a hygroscopic material, uneven absorption of moisture may cause the substrate to expand, which also may cause the substrate to warp and stress the coating, again leading to the occurrence of interruptions in the continuity of the coating.

One approach to overcoming the problems associated with non-uniform deposition of coating powders is to spray a conductive primer coating to provide even conductivity at the surface of the substrate, with or without preheating. In many coating applications, however, substrate surfaces are machined, e.g., routed, to include grooves, channels, or intricate designs. Because of the contoured surfaces characteristic of the grooves, channels, or intricate designs, surfaces therein are difficult at best to evenly coat with conventional pre-heat/electrostatic spray methods. In particular, edges and sharp corners are dried out by the pre-heating process, which reduces the moisture content of the substrate proximate these areas to the point that electrostatic attraction between the coating powder and the surface at the edges and comers is difficult. The result is a non-uniform application of the coating powder. Such non-uniformity causes bare, uncoated areas on the substrate and ultimately results in warping of the substrate and stressing of the coating.

Accordingly, there remains a need for a method of powder coating non-metallic substrates such that a more uniform application of the coating powdered is disposed at the surface of the non-metallic substrate.

### SUMMARY

A method of powder coating a non-metallic substrate includes cooling the non-metallic substrate, condensing a vapor at a surface of the non-metallic substrate, and disposing a coating powder at the condensed vapor at the surface of the non-metallic substrate.

### DETAILED DESCRIPTION

The application of a layer of finely divided moisture droplets to the surface of a non-conductive, non-metallic substrate at which a powder coating is to be applied allows a more uniform coating to be deposited on the substrate. With uniform coating of the substrate, the shrinkage or expansion of the substrate is controlled and minimized. In particular, differences in the shrinkage or expansion between various portions of the substrate are minimized to limit the amount of warping, thereby reducing the possibility that the coating will be stressed. Avoiding or reducing stresses placed on the coating substantially reduces the amount and severity of surface defects.

Suitable non-metallic substrates include but are not limited to glass, paper, ceramic, and graphite-filled filled materials, as well as lignocellulosic materials (e.g. both hard and soft woods in their natural forms, shaped, or chipped into particleboard), engineered woods such as fiberboard, and plastics, for example acrylonitrile/butadiene/styrene (ABS) plastics. Of course, metallic substrates may also be use. The substrate may be shaped to have an appearance surface (a surface that is generally visible) that is typically decoratively configured, e.g. routed or otherwise machined to include a design, which may be a groove, a channel, or an intricate pattern. Examples of substrates having appearance surfaces that include such designs include those that are formable into cabinet doors, tabletops, and trim moldings.

Where fiberboard is used as the substrate, it is generally of a medium density and comprises wood fibers and wood particles mixed with a binding resin. The mixture is then hot-pressed to the general shape of the finished product. The fiberboard is then cured to enable the resin to set, thereby allowing the substrate to retain its shape and giving the substrate its structural integrity. The moisture content of the fiberboard at this point is about 5% to about 7% on a weight/weight basis. Once cured, the fiberboard can be machined to include the desired aesthetic configurations, as well as functional openings and channels that allow for the out-gassing of volatile organic carbons (VOCs) from core regions of the fiberboard. Subsequent to the machining process, the coating powder is applied to the fiberboard.

In the application of a coating powder the substrate, the surface of the substrate is wetted via condensation, i.e., the transfer of water molecules from a vapor phase to a liquid phase. Condensation results from the contact of a surface at a first temperature with a vapor, preferably a saturated vapor, at a second, higher temperature. A saturated vapor is one that is in a state of thermodynamic equilibrium, i.e., in a state in which the rate of water molecules entering the vapor equals the rate of water molecules leaving the vapor. By subsequently contacting the surface at the first temperature with the saturated vapor at the second, higher temperature, the equilibrium is “bumped,” causing it to shift such that the rate of water molecules leaving the vapor is greater than the rate at which water molecules enter the vapor, thereby causing the deposition of a liquid phase at the surface.

The particular temperatures to which the substrate is cooled (the first temperature) and at which the vapor is maintained (the second temperature) as well as the concentration of the vapor are readily determined by one of ordinary skill in the art, based on the identity of the vapor (e.g., water, which is preferred), the identity of the substrate, cost of cooling, means of cooling, vapor concentration (i.e., % humidity), and the like. Preferably, the first temperature to which the surface is cooled is less than the freezing point of water. In general, transfer of a substrate cooled to less than 0° C., i.e., −5° C., to an atmosphere having 50 to 80% or more humidity at room temperature will result in deposition of a thin film of moisture.

Deposition of the liquid phase (or condensate) may be either film condensation or dropwise condensation. Film condensation is generally characterized by more finely divided droplets that form a film over the surface, wherein the thickness of the film increases with an increase in the surface area covered. Dropwise condensation is characterized by the non-uniform wetting of the surface such that the condensate appears in small droplets at various points on the surface. Film condensation is preferred because it provides for a more uniform deposition of water on the substrate. In particular, film condensation provides for less variation in film thickness between the relatively large planar areas of the substrate and the surfaces defined by grooves, edges, and intricate patterns that may be machined into the substrate.

Condensation imparts a conductivity having very little variation over the surface area, which allows the coating powder to more uniformly adhere to the surfaces of the substrate. Because the condensation is substantially uniformly thick, thereby minimizing the variation in the electrostatic attraction between the coating powder and the substrate, a coating powder is deposited on the substrate that yields a powder coating having a substantially uniform thickness. Prior to the hardening of the coating powder into the powder coating, the condensed moisture evaporates through and out of the coating powder deposited on the substrate prior, thereby minimizing the formation of defects (e.g., pinholes, blisters, craters, and the like) on the finished surface.

Suitable coating powders are known, and usually comprise a solid, thermoplastic or thermosetting film-forming polymer resin. A number of different types thermoplastic resins for coating powders are known, for example vinyl chloride, polyamides, celluloses, polyolefins, polyethylene, and polyesters. Thermosetting film-forming resins contain reactive functional groups, an optional curing agent (crosslinking agent) having functional groups reactive with the functional groups of the polymer resin, and which may itself be another film-forming polymer, and an optional catalyst. Known thermosetting resins include but are not limited to acid-functional polyester resins, acid-functional acrylic resins, epoxy resins, and hydroxy-functional polyester resins. The powders are generally supplied having a particle size of 20 to 120 micrometers, preferably 30 to 80 micrometers.

The coating powder may then be applied to substrates by conventional means, including electrostatic fluidized beds, electrostatic spray guns, triboelectric guns, and the like, in which the powder coating particles are electrostatically charged and the substrate is grounded or oppositely charged. Coating powders are generally applied to achieve a coating thickness of 1.0 mil (0.0245 millimeters, “mm”) to 25 mils (0.6125 mm). The coating as deposited on a metal substrate is preferably 1.5 to 4 mils (0.0367 to 0.0980 mm) thick. The coating as deposited on a non-metallic substrate is preferably 3 to 10 mils (0.0735 to 0.245 mm) thick, with 3 to 6 mils (0.0735 to 0.147 mm) thick being more preferred.

After application to the substrate, the applied coating powder is fused (generally by heating the substrate) and may be cured, generally at a temperature of 200 to 500° F. (93.3 to 260° C.), preferably 220 to 450° F. (104 to 232° C.), more preferably 250 to 400° F. (121 to 204° C.). Where low curing temperatures are desired, for example with wood substrates cure is generally less than 325° F. (163° C.), more preferably less than 300° F. (149° C.), even more preferably less than 250° F. (121° C.).

The present method has a number of advantages over the prior art. It is economical, and does not require special or expensive equipment. It allows deposition of uniform coatings, thereby minimizing or eliminating surface defects, particularly surface defects formed over time. It is particularly advantageous where the surface of the substrate is uneven, because preheating of these surfaces is particularly prone to risk of uneven deposition and evaporation or adsorption.

What is claimed is:

1. A method of powder coating a substrate, the method comprising:
cooling the substrate;
condensing a vapor at a surface of the substrate; and
disposing a coating powder at the condensed vapor at the surface of the substrate.

2. The method of claim 1, wherein the vapor is water.

3. The method of claim 1, wherein the substrate is non-metallic.

4. The method of claim 3, wherein the non-metallic substrate is fiberboard or engineered wood.

5. The method of claim 1, wherein the non-metallic substrate is cooled to a temperature of less than about the freezing point of water.

6. The method of claim 1, wherein condensing the vapor comprises contacting the cooled substrate with vapor, wherein the contacting is at a temperature greater than the temperature to which the non-metallic substrate is cooled.

7. The method of claim 1, wherein disposing is by electrostatically adhering the coating powder to a film of the condensed vapor.

8. The method of claim 1, further comprising fusing the coating powder at the condensed vapor to form a powder coating.

9. The method of claim 1, further comprising fusing and optionally curing the deposited coating powder to provide a powder coating.
